(19) United States
(12) Patent Application Publication
(10) Pub. No.: US 2020/0018056 A1
(43) Pub. Date: Jan. 16, 2020

(54) VENTURI AND SALINITY MONITORING SYSTEM AND METHOD FOR VACUUM SEWER COLLECTION SYSTEMS

(71) Applicants: Edward Robert Castle, Marathon, FL (US); Daniel Edward Saus, Green Cove Springs, FL (US); Stephen James Suggs, Big Pine Key, FL (US)

(72) Inventors: Edward Robert Castle, Marathon, FL (US); Daniel Edward Saus, Green Cove Springs, FL (US); Stephen James Suggs, Big Pine Key, FL (US)

(21) Appl. No.: 16/507,868

(22) Filed: Jul. 10, 2019

Related U.S. Application Data
(60) Provisional application No. 62/763,907, filed on Jul. 10, 2018.

(51) Int. Cl. E03F 1/00; G05B 19/042

(52) U.S. Cl. CPC E03F 1/006; G05B 19/0428

(57) ABSTRACT

A vacuum sewer monitor includes a venturi pipe having an inlet portion, a choke portion, and an outlet portion. The choke portion includes a smaller diameter than the entrance portion and the outlet portion. A first pressure sensor is configured to read a level of pressure at the inlet portion. A second pressure sensor configured to read a level of pressure at the choke portion. A transmitter is configured to send the levels of pressure of the first pressure sensor and the second pressure sensor to a remote computing system.

### CROSS-REFERENCE TO RELATED APPLICATION

This application claims the benefit of priority of U.S. provisional application No. 62/763,907, filed Jul. 10, 2018, the contents of which are herein incorporated by reference.

### BACKGROUND OF THE INVENTION

The present invention relates to system and method for evaluating the performance of vacuum sewer collection systems and, more particularly, to a system and method for estimating velocities, flow rates and pressures throughout the vacuum sewer collection system piping network.

Conventional methods for measurement and evaluation of performance of vacuum sewer collection systems includes monitoring of static vacuum pressure gages, volume of liquid wastewater collected, and monitoring of vacuum pump run times and sewage pump run times. Some systems employ the use of cycle counters which record the number of events at individual vacuum valves.

Conventional methods for locating sources of air or liquid inflow include visual inspection of air intakes and operation of division valves located throughout the vacuum sewer collection system. In this conventional method, to check the performance of individual vacuum sewer mains, a division valve is closed, and the static vacuum pressure gages are be monitored to determine if closing the valve causes changes in the vacuum conditions. This trial-and-error method of determining the current condition of the performance of individual vacuum mains is time consuming and lacking in detailed information.

While these methods of monitoring and trouble-shooting the performance of vacuum sewer collection systems have been used routinely and have generally been adequate to prevent system failures and spills of raw sewage, it is frequently difficult and time-consuming to locate failures within the vacuum sewer collection system. These methods also provide little guidance for optimization of the performance characteristics of the individual vacuum sewer mains and provide no indication of localized changes in flow or use in the individual vacuum mains.

As can be seen, there is a need for a more efficient and more comprehensive method of measuring performance of vacuum sewer collection systems

### SUMMARY OF THE INVENTION

In one aspect of the present invention, a vacuum sewer monitor comprises: a venturi pipe comprising an inlet portion, a choke portion, and an outlet portion, wherein the choke portion comprises a smaller diameter than the entrance portion and the outlet portion; a first pressure sensor configured to read a level of pressure at the inlet portion; a second pressure sensor configured to read a level of pressure at the choke portion; and a transmitter configured to send the levels of pressure of the first pressure sensor and the second pressure sensor to a remote computing system.

In another aspect of the present invention, a system for monitoring a sewer system comprises: a plurality of vacuum sewer monitors each comprising: a venturi pipe comprising an inlet portion, a choke portion, and an outlet portion, wherein the choke portion comprises a smaller diameter than the inlet portion and the outlet portion; a first pressure sensor configured to read a level of pressure at the inlet portion; a second pressure sensor configured to read a level of pressure at the choke portion; and a transmitter, wherein each of the plurality of vacuum sewer monitors is coupled to a sewer pipe of the sewer system at different locations; and a remote computing system comprising a processor, a memory and a display, wherein the processor displays a digital representation of a geographic location of each of the plurality of vacuum sewer monitors, receives the levels of pressure of the first pressure sensor and the second pressure sensor from each of the plurality of vacuum sewer monitors via the transmitters; calculates pressure differentials between the inlet portion and the choke portion for each of the plurality of vacuum sewer monitors, and produces an alert if at least one of the pressure differentials is irregular.

These and other features, aspects and advantages of the present invention will become better understood with reference to the following drawings, description and claims.

### BRIEF DESCRIPTION OF THE DRAWINGS

FIG. 1 is a schematic view of vacuum sewer monitor coupled to a sewer line;

FIG. 2 is a schematic view of a vacuum sewer monitor;

FIG. 3 is a schematic view of vacuum sewer monitors coupled within a sewer system;

FIG. 4 is a schematic view of vacuum sewer monitors coupled within a sewer system;

FIG. 5 is a schematic view of vacuum sewer monitors coupled within a sewer system; and

FIG. 6 is a schematic view of vacuum sewer monitors coupled within a sewer system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method for estimating velocities, flow rates and pressures throughout the vacuum sewer collection system piping network. The present invention provides for a system and method of continuously and accurately monitoring the performance of vacuum sewer collection systems, including the performance of individual vacuum mains and branches. Additionally, the present invention provides notice of anomalies in the performance of vacuum sewer collection systems and allows for locating system leaks, blockages and other failures quickly. An objective of the present invention is to allow for identification and correction of failures of vacuum collection systems more quickly and more efficiently than the currently used methods, thereby preventing releases of raw sewage to the environment and protecting public health and welfare.

The present invention is based on velocity measurements of flow in pipes operating at negative pressures. The fluid in the pipes is a multi-phase mixture of air, water and waste solids. A venturi is appropriate for measuring velocity of the multi-phase fluid if fitted with the proper pressure sensing devices for operating and vacuum pressures as low as 30 inches of mercury. The invention consists of a venturi of appropriate diameter, materials and fittings compatible with the size of the vacuum sewer main into which it will be installed. The pressure measuring devices will transmit pressure readings via an appropriate electrical signal to a processor where the data will be used to calculate velocity and to estimate flow rates. The venturi units will be housed in manholes or other appropriate structures.

The present invention includes the innovative concept of measuring both the static pressure at the venturi entrance and the differential pressure between the venture entrance and the venturi throat of venturis placed inline at specific locations within a vacuum sewer collection system. The pressure measuring devices at the venturi entrances measure the level of static vacuum at those locations. The pressure measuring devices in the throat of the venturis measures the reduced pressure created by the increased velocity in the throat of the venturis. These data are used to calculate the velocity of the mixed air/liquid/solid slurry that is passing through the venturis. Based on the design air:liquid ratio for the vacuum sewer collection system, the velocities as determined by the pressure differentials in the venturis can be used to estimate a volumetric flow rate at those points in each vacuum sewer main.

The information collected by the present invention is transmitted to a central monitoring facility where the velocity information can be used to monitor system performance and assist in identifying and locating vacuum sewer collection system malfunctions. The processed data are used to generate alerts and alarms when malfunctions occur and can identify the vacuum main or branch that has malfunctioned. The data can also be used to identify changes in use by trending estimated flows.

The method of the present invention is particularly suited for identifying and locating unintended inflow of air or water. One of the most common failures of vacuum sewer collection systems is excessive inflow of air through either a malfunctioning vacuum valve or a broken vacuum pipe, either of which allows excessive air to enter the vacuum sewer collection system. This results in exhaustion of the vacuum throughout the vacuum sewer collection system, resulting in total system shut-down. The current method of identifying this type of failure requires manual sequential operation of multiple valves throughout the entire vacuum collection system in a trial-and-error method of isolating vacuum mains and then the branch mains while monitoring static vacuum pressure until the source of the leak is found. The present invention identifies a path of high velocities at each installed monitor, from the point of the air leak back to the vacuum pump station. This allows personnel to mobilize directly to the area of the leak, saving hours of manpower and potentially preventing releases of raw sewage into the environment and potentially into the homes and businesses of the vacuum sewer system users.

The method of the present invention is also particularly suited for identifying inflow of water. Excessive water can enter a vacuum sewer system from leaks in the property-owner's sanitary drainage system and from leaks in vacuum pit structures. This results in more frequent cycling of the vacuum valves, increasing the velocity in the vacuum mains. The present invention monitors the velocity in the vacuum mains and vacuum branches. If an unexpected increase in average velocity occurs at a monitored location, the change can be identified by an increase in the calculated average fluid flow. The present invention also employs a conductance probe to estimate salinity of the water. The salinity of the water at each location assists in identifying and locating inflow of saline waters in coastal areas where the groundwater can be brackish to saline.

The data generated by the present invention can be used to identify additional important performance criteria. The static vacuum pressure as measured at the entrance of the venturis can be used to identify blockages in piping, water logging of vacuum mains and areas where the vacuum levels may be insufficient for optimal performance. The average velocities in the vacuum mains and vacuum branches can be used to track diurnal and seasonal use pattern and can be used to monitor the impacts of ground water elevation, rain events and other sources of inflow and infiltration. These data can be used to plan for future expansions and to make system adjustments based on expected diurnal or seasonal variations.

The present invention advances the art of vacuum sewer system design, operation and maintenance providing for more efficient collection of sanitary waste and helping reduce the potential for unintended releases of raw wastewater, thereby protecting the environment and public health.

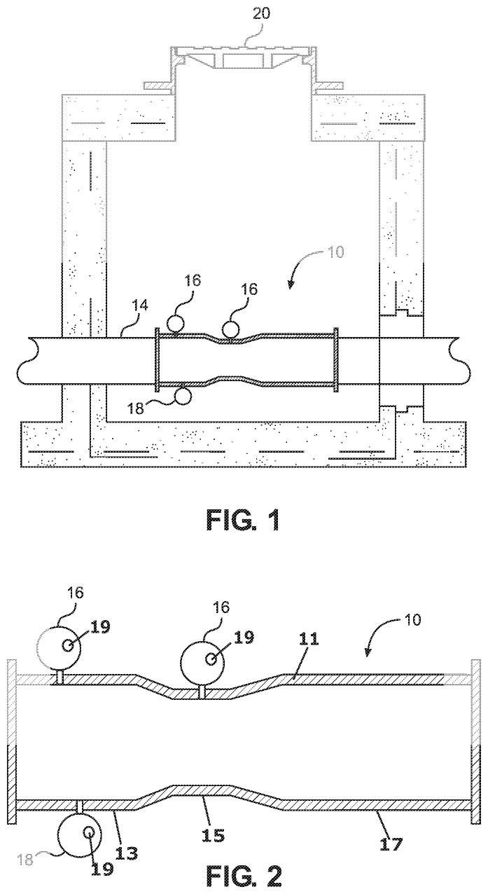

FIGS. 1 and 2 depicts cross-sectional views of a vacuum sewer monitor 10 and the installation of the vacuum sewer monitor 10. The vacuum sewer monitor 10 includes a venturi pipe 11 having an inlet portion 13, a choke portion 15, and an outlet portion 17. A first pressure sensor 16 and a second pressure sensor 16 are coupled to the inlet portion 13 and the choke portion 15 respectively. The pressure sensors 16 may detect vacuum pressures ranging from atmospheric pressure to approximately 30 inches of mercury. The pressure sensors 16 may be constructed of corrosion-resistant material suitable for exposure to wastewater and brackish or saline water. A salinity measuring device 18 is similarly constructed and provides measurements of salinity in a range from zero to 40 parts per thousand. The pressure sensors 16 and salinity measuring devices 18 may be coupled flush with the inner walls of the venturi pipe 11 to avoid excessive head losses and to avoid entrapment of entrained solids and fibrous materials commonly found in wastewater streams.

As fluid flows through a venturi pipe 11, the constriction of the diameter at the choke portion 15 causes the fluid velocity to increase as the cross-sectional area decreases. The higher velocity of the fluid in the choke portion 15 of the venturi pipe 11 causes a decrease in the pressure exerted by the fluid at the walls of the venturi pipe 11 according to Bernoulli's Principle. The velocity of the fluid passing through the venturi pipe 11 can be calculated from the pressure differential between the inlet portion 13 and the choke portion 15. In the present invention, the differential pressure is used to calculate the velocity of the multi-phase slurry passing through the vacuum sewer monitor 10. Using the design air:liquid ratio for the vacuum collection system, the velocity can be used to calculate the estimated volumetric flow rate of wastewater at that point in the vacuum sewer collection system. The static vacuum pressure in the vacuum mains can be obtained from the first pressure sensor 16 located at the inlet portion 13 of the venturi pipe 11. The salinity measuring device 18 can be installed in any convenient location in the venturi pipe 11, provided that it does not create turbulence in proximity to the pressure sensors 16.

The pressure sensors 16 and the salinity measuring device 18 may be powered by an external power supply. The output from pressure sensors 16 and the salinity measuring device 18 is transmitted via transmitters 19 to a monitoring station having a computing system where the signals are logged and computations are made to calculate the various performance data indicators for the vacuum sewer collection system.

FIG. 1 depicts one of several potential installation options. In this case, the present invention is installed in a standard manhole 20. The vacuum sewer monitor 10 can be installed to a sewer pipe 14 using flanged fittings, mechanical couplers or any standard pipe fitting method. The present invention may be installed below a manhole 20 or other enclosure so that the vacuum sewer monitor 10 can be accessed for maintenance without excavation.

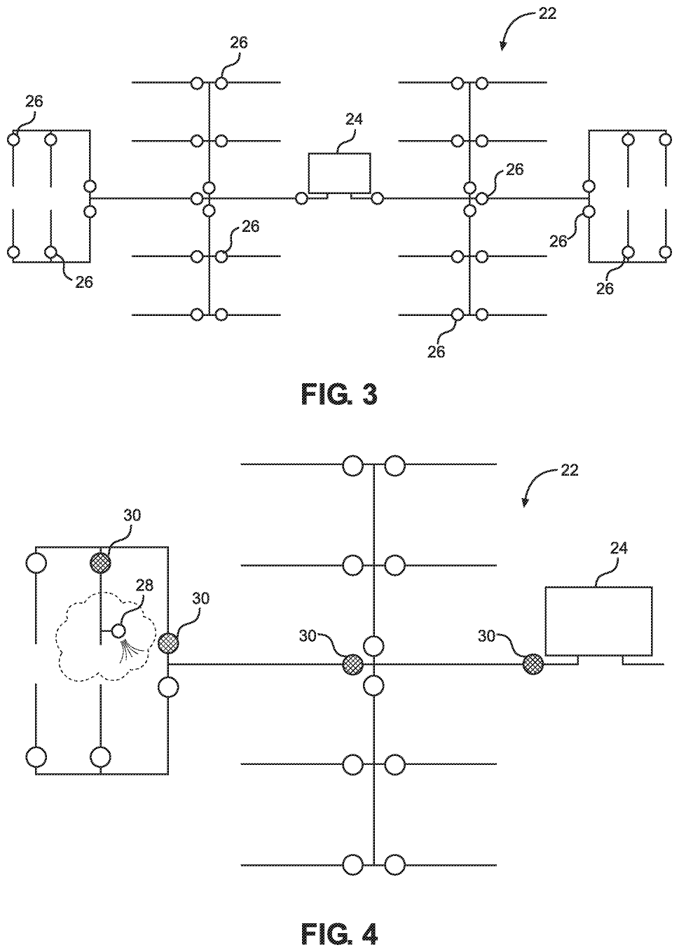

FIG. 3 depicts a digital representation 22 of a vacuum sewer collection system. The digital representation 22 may be displayed on a remote computing system of a monitoring station 24. The remote computing system includes a processor, a memory and a display. The digital representation 22 is depicted on the display. The digital representation 22 is of a geographic location of each of the plurality of vacuum sewer monitors 26. The remote computing system receives the levels of pressure of the first pressure sensor and the second pressure sensor from each of the plurality of vacuum sewer monitors via the transmitters; calculates pressure differentials between the inlet portion and the choke portion for each of the plurality of vacuum sewer monitors 26, and produces an alert if at least one of the pressure differentials is irregular.

Referring to FIG. 4 is an example of the use of the present invention's technology to identify that a failure has occurred and how the present invention's technology identifies the failure and provides the approximate location of the failure is presented. In this example, the failure is a vacuum valve 28 stuck in the open position. This is one of the more common failures experienced in a vacuum sewer collection system. When a vacuum valve 28 fails to close, it leaves an open 3-inch conduit to the atmosphere, allowing excessive air to enter the system, causing a low vacuum condition. The low vacuum condition can cause the entire system to cease functioning, creating the potential for raw wastewater to discharge into the environment or to back up into homes and other buildings, creating a nuisance and a potential hazard to public health and welfare.

The digital representation 22 produces an alert 30 of points of high velocity along the path of the vacuum main and branch mains immediately after the vacuum valve fails to close. Vacuum sewer monitors detect the high velocity points and the data is transmitted to the monitoring system 24 indicating that excessive air flow is occurring. The velocity pattern shown by the present invention's monitoring devices directs personnel to the branch vacuum main that is the source of the excessive air flow. Knowing that location, the personnel can eliminate the time-consuming trial-and-error division valve method of identifying which branch of the vacuum sewer collection system is the source of the excessive air flow and proceed to the location to effect repairs.

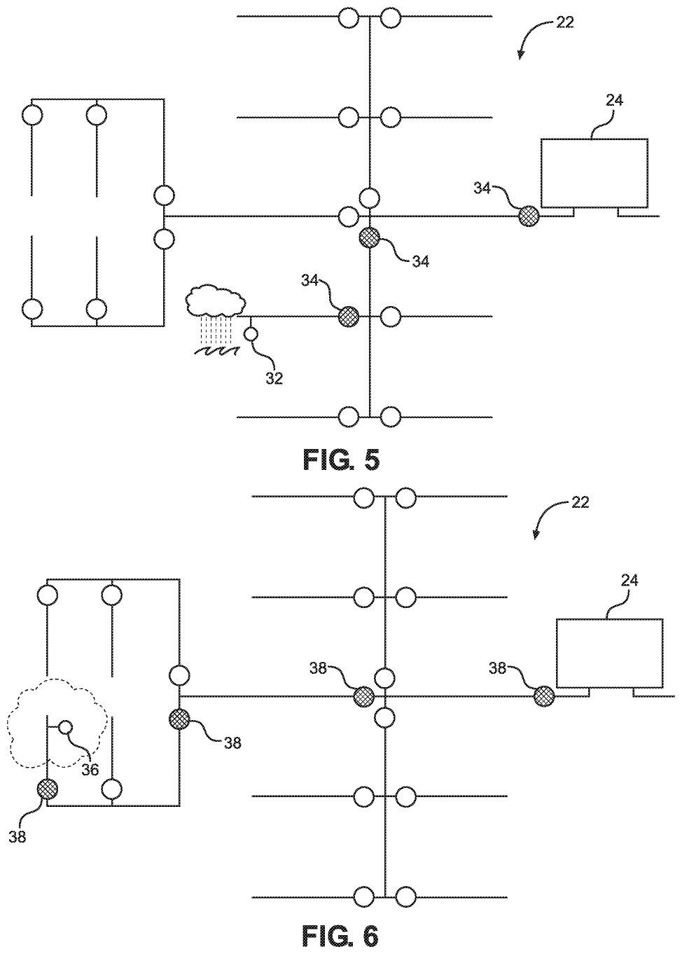

FIG. 5 illustrates how the present invention's technology identifies the occurrence of inflow into the vacuum sewer collection system during rainfall events and identifies the area 32 in which the inflow is occurring. The velocity data is used to estimate wastewater flows at each monitoring point based on the design air:liquid ratio. This data is logged into the central monitoring system 24 where average flow rates at each point are maintained. If there is significant inflow into the vacuum sewer collection system, the calculated flow increases above the average flow for the monitoring points. FIG. 5 depicts a digital representation 22 of an instance of inflow during rain events. As shown in the example, higher than normal flow rates are detected by vacuum sewer monitors and downstream at the monitoring station 24. The central monitoring station 24 can be programmed to initiate an alert 34 of the condition on the digital representation 22, indicating a location of the vacuum sewer monitors that are detecting the inflow.

FIG. 6 is a schematic diagram demonstrating how the present invention's technology identifies the presence of infiltration of saline waters and identifies the area 36 of the infiltration. In coastal areas, the groundwater tends to be brackish to saline. The present invention's salinity measurement devices provide salinity measurements allowing for saline infiltration to be detected and the area 36 of the infiltration to be identified. In this example, a service lateral has been broken in a location close to the coast, allowing saline groundwater to enter the vacuum sewer collection system. A salinity measuring device of a vacuum sewer monitor detects the increased salinity at the area 36. As the saline flow travels downstream in the vacuum sewer collection system, the vacuum sewer monitors show salinity levels that are higher than normal. The central monitoring station 24 can be programmed to initiate an alert 38 of the condition on the digital representation 22, clearly indicating the approximate location of the source of saline groundwater infiltration.

It should be understood, of course, that the foregoing relates to exemplary embodiments of the invention and that modifications may be made without departing from the spirit and scope of the invention as set forth in the following claims.

What is claimed is:

1. A vacuum sewer monitor comprising:
a venturi pipe comprising an inlet portion, a choke portion, and an outlet portion, wherein the choke portion comprises a smaller diameter than the entrance portion and the outlet portion;
a first pressure sensor configured to read a level of pressure at the inlet portion;
a second pressure sensor configured to read a level of pressure at the choke portion; and
a transmitter configured to send the levels of pressure of the first pressure sensor and the second pressure sensor to a remote computing system.

2. The vacuum sewer monitor of claim 1, further comprising the remote computing system, wherein the remote computing system comprises a processor, a memory, and a display.

3. The vacuum sewer monitor of claim 2, wherein the processor
calculates a pressure differential between the inlet portion and the choke portion.

4. The vacuum sewer monitor of claim 3, wherein the processor
displays a digital representation of a geographic location of the vacuum sewer monitor; and
produces an alert if the pressure differential is irregular.

5. The vacuum sewer monitor of claim 1, further comprising a salinity measuring device configured to read a level of salinity, wherein the transmitter is configured to send the level of salinity to the remote computing system.

6. A system for monitoring a sewer system comprising:
a plurality of vacuum sewer monitors each comprising:
a venturi pipe comprising an inlet portion, a choke portion, and an outlet portion, wherein the choke portion comprises a smaller diameter than the inlet portion and the outlet portion;
a first pressure sensor configured to read a level of pressure at the inlet portion;
a second pressure sensor configured to read a level of pressure at the choke portion; and
a transmitter, wherein
each of the plurality of vacuum sewer monitors is coupled to a sewer pipe of the sewer system at different locations; and
a remote computing system comprising a processor, a memory and a display, wherein the processor
displays a digital representation of a geographic location of each of the plurality of vacuum sewer monitors,
receives the levels of pressure of the first pressure sensor and the second pressure sensor from each of the plurality of vacuum sewer monitors via the transmitters;
calculates pressure differentials between the inlet portion and the choke portion for each of the plurality of vacuum sewer monitors, and
produces an alert if at least one of the pressure differentials is irregular.

7. The system of claim 6, wherein the alert comprises digitally highlighting the at least one of the plurality of vacuum sewer monitors that is providing the irregular pressure differential.

8. The system of claim 6, wherein each of the plurality of vacuum sewer monitors further comprises a salinity measuring device configured to read a level of salinity, wherein the processor receives the levels of salinity from each of the plurality of vacuum sewer monitors via the transmitters.

9. The system of claim 8, wherein the processor produces an alert if at least one the levels of salinity is irregular.

10. The system of claim 9, wherein the alert for the irregular levels of salinity is different from the alert for the irregular pressure differentials.
